(19) United States
(12) Patent Application Publication
(10) Pub. No.: US 2010/0320291 A1
(43) Pub. Date: Dec. 23, 2010

(54) CLOSED CAPILLARY WATER DISTRIBUTION SYSTEM FOR PLANTERS

(76) Inventor: Guang-Yau Stanley Chen, Neipu Township (TW)

Correspondence Address: Yen Jung Sung, 21-80 38 St, #C8, Astoria, NY, 11105, US

(21) Appl. No.: 12/819,156

(22) Filed: Jun. 18, 2010

(30) Foreign Application Priority Data
Jun. 18, 2009 (TW) 098120402

(51) Int. Cl. A01G 25/02; F16L 9/18

(52) U.S. Cl. 239/450; 138/111

(57) ABSTRACT

A system for transporting water from a water reservoir in lower position to planters for watering plants therein includes a conduit having one end immersed in the water reservoir and the other end closed or connected to a pressured water source, the conduit running through undersides of the planters; and a plurality of capillary tubes each having one end in communication with water flowing in the conduit, and the other end in communication with medium within each planter.

### BACKGROUND OF THE INVENTION

1. Field of Invention

The invention relates to planters and more particularly to a close capillary system for distributing water to planters.

2. Description of Related Art

Traditionally, plants are watered manually. This is a considerable burden on the service personnel who must ensure each plant is properly watered. For saving time and costs, and solving problems associated with plant watering, many proposals including patents have been disclosed throughout the world.

For example, Taiwan Utility Model Patent Publication Number M324,970 discloses a self-watering planter as shown in FIG. 1. It comprises a lower water pan 11 and a pan shaped upper planter portion 12 which is adapted to mount on the water pan 11 by snapping. The planter portion 12 comprises a plurality of flow holes 121 on the bottom. A plurality of capillary tubes 13 each has one end terminated at the upper mouth of the flow hole 121 and the other end disposed above bottom of the water pan 11 by a small distance. A plurality of plants (not shown) and medium are placed in the planter portion 12. Water is automatically drawn upward to the roots of the plants along the capillary tubes 13.

However, a drawback has been found. In detail, a service personnel has to detach the planter portion 12 from the water pan 11 prior to pouring water into the water pan 11 for replenish. This is a somewhat inconvenient if the fastening of the planter portion 12 and the water pan 11 jams. Also, it could be awkward when handling a large number of planters.

Further, Taiwan Utility Model Patent Publication Number M282,489 discloses a water distribution system for planters as shown in FIG. 2. It comprises a conduit 22 having one end bent and immersed in a water reservoir 21 which functions similar to a toilet tank of a typical toilet. A plurality of stations 222 are provided along the conduit 22. Each station 222 is connected to a section 221 of the conduit 22. A first capillary material 23 is provided in and along the entire length of the conduit 22. A plurality of branches 231 of the first capillary material 23 each is placed within one of a plurality of planter portions 24. A second capillary material 25 is placed in each planter portion 24 and is in a partial covering relationship to the branch 231 of the first capillary material 23. The stations 222 and sections 221 of the conduit 22 are disposed under the planter portions 24. This capillary system interconnects the planters and the water reservoir, and is advantageous as claimed by the patentee because water is absorbed from the water reservoir by capillary materials and ultimately fed into medium of the planter, thereby moistening the medium.

However, a number of drawbacks have been found. In detail, the more distal from the water reservoir 21 the slower water will be transported to the planter. Hence, this configuration is only appropriate for small areas. The rate of water absorbed by the first capillary material 23 will be significantly lowered if water level of the water reservoir 21 is lower than the conduit 22 (i.e., sections 221 of conduit 22). The arrangement of the water distribution system is somewhat complicated. Its desired water distribution performance is much less than expected. A portion of the first capillary material 23 between the bottom flow hole 241 of the planter portion 24 and the top opening of the station 222 is exposed. The problem of insufficient watering becomes significant due to evaporation in the exposed portion of the first capillary material 23. The growing of microorganisms (e.g., bacteria, algae) could cause potential diseases contamination. Thus, the need for improvement still exists.

### SUMMARY OF THE INVENTION

It is therefore one object of the invention to provide a system for transporting water from a water reservoir to planters for watering plants therein, comprising a conduit having one end immersed in the water reservoir and the other end closed or connected to a pressured water source, the conduit running through undersides of the planters; and a plurality of capillary tubes each having one end in communication with water flowing in the conduit, and the other end in communication with medium within each planter. The capillary tubes are releasable.

Hence, an extension and continuum of capillary rise is generated through out the capillary tubes and the conduit, and water could be taken up from a position much lower than the capillary tubes'.

The above and other objects, features and advantages of the invention will become apparent from the following detailed description taken with the accompanying drawings.

### BRIEF DESCRIPTION OF THE DRAWINGS

FIG. 1 is an exploded view of a typical self-watering planter;

FIG. 2 is a longitudinal sectional view of a typical water distribution system for planters;

FIG. 3 is a longitudinal sectional view of a closed capillary water distribution system for planters according to a first preferred embodiment of the invention;

FIG. 4 is a top plan view of a closed capillary water distribution system for planters according to a second preferred embodiment of the invention; and

FIG. 5 is a longitudinal sectional view of a closed capillary water distribution system for planters according to a third preferred embodiment of the invention.

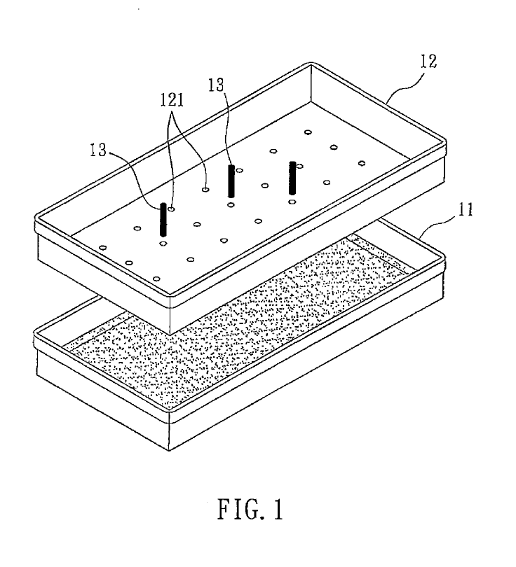

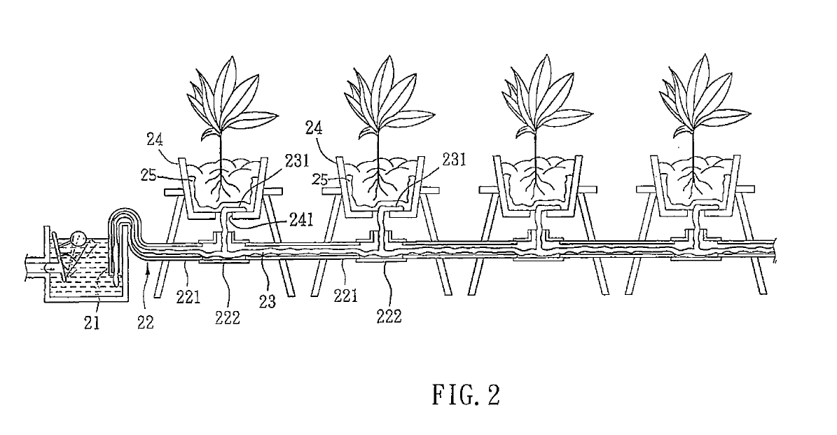

### DETAILED DESCRIPTION OF THE INVENTION

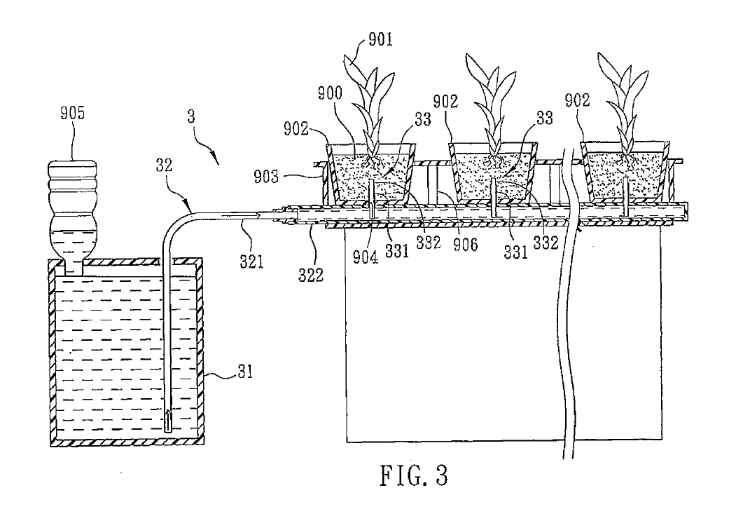

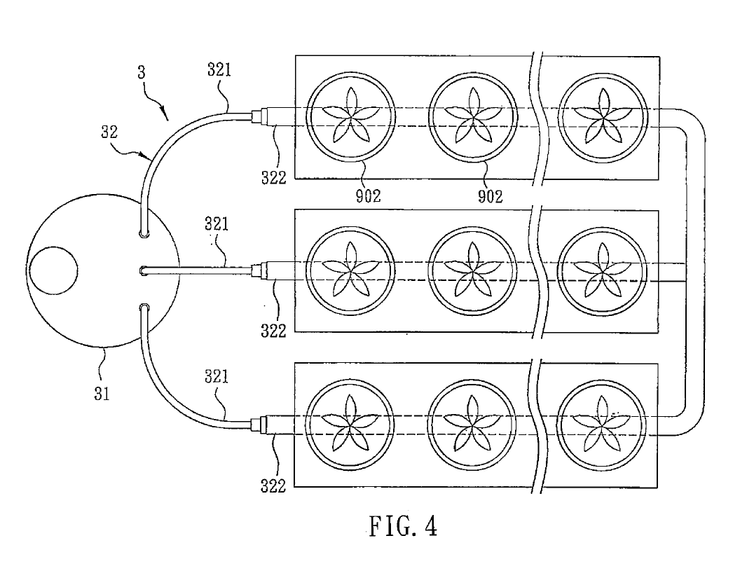

Referring to FIG. 3, a closed capillary water distribution system 3 for planters in accordance with a first preferred embodiment of the invention comprises the following components as discussed in detail below.

A water reservoir 31 has a water container 905 disposed on top. The water container 905 is inverted to have its opening disposed below the top of the water reservoir 31 so that water in the water container 905 can flow into the water reservoir 31 for replenishing automatically. Water level of the water reservoir 31 is always kept at the height of the opening of water container 905 as long as there is water in the water container 905. It is understood that a service employee may refill the water container 905 if the water container 905 becomes nearly empty or simply pour water into the water reservoir 31. This can be done in a substantially regular period of time if the water consumption of the configuration is substantially constant.

A peripheral frame 903 has a plurality of planters 902 disposed therein. The planter 902 has a bottom hole 904. Any two adjacent planters 902 are separated by a frame element 906. That is, the planters 902 are disposed in a compartmented frame structure. Medium 900 is filled in the planter 902. A plant 901 is placed in the medium 900, and the medium 900 can be different types of growing medium.

A plurality of water distribution units 33 each comprises a short tube 331 and an absorbent element 332. The short tube 331 extends through the bottom hole 904. The absorbent element 332 is set in the short tube 331 and has a top open end disposed in the medium 900.

A conduit assembly 32 comprises a bent interconnecting pipe 321 having one open end disposed proximate to the bottom of the water reservoir 31 and the other end connected to a conduit 322. The conduit 322 runs through undersides of the planters 902 and has a closed end distal the interconnecting pipe 321. The lower end of the short tube 331 is attached to the surface hole (not shown) of the conduit 322 to let the absorbent element 332 disposed inside the conduit 322. The tubes 331 and absorbent elements 332 are separate parts and can be assembled at site when installing the system.

It is envisaged by the invention that the absorbent element 332 is of porous material so that a capillary action can occur (i.e., the absorbent element 332 being an entity of numerous capillary tubes). Hence, water may flow from the water reservoir 31 to the medium 900 via the interconnecting pipe 321, the conduit 322, and the hole 904. Moreover, water may flow through and moisten the medium 900 when the water potential becomes lower in the medium 900. This closed water distribution system can reduce undesired evaporation to a minimum and extend the capillary rise through conduit 322 and pipe 321. Furthermore, it is capable of sufficiently watering plants within multiple planters arranged in different patterns and/or areas.

Referring to FIG. 4, a closed capillary water distribution system for planters in accordance with a second preferred embodiment of the invention is characterized below. Three parallel rows of planters 902 and three conduit assemblies 32 are provided. The second embodiment is a simple expansion of the first embodiment with the characteristics of closed capillary system remained same.

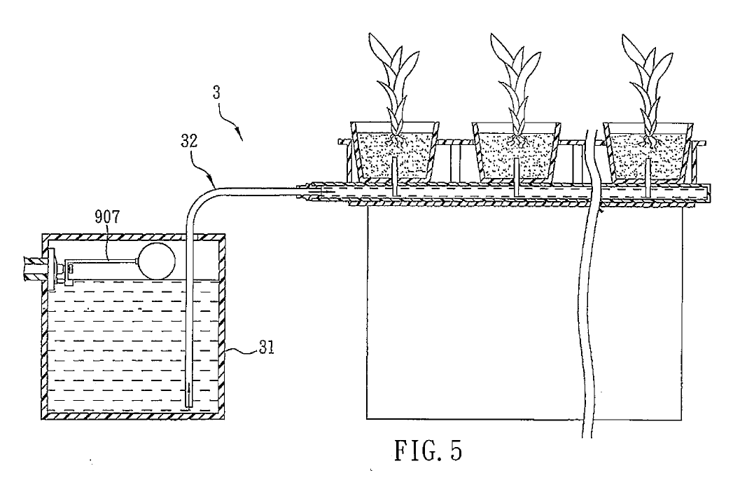

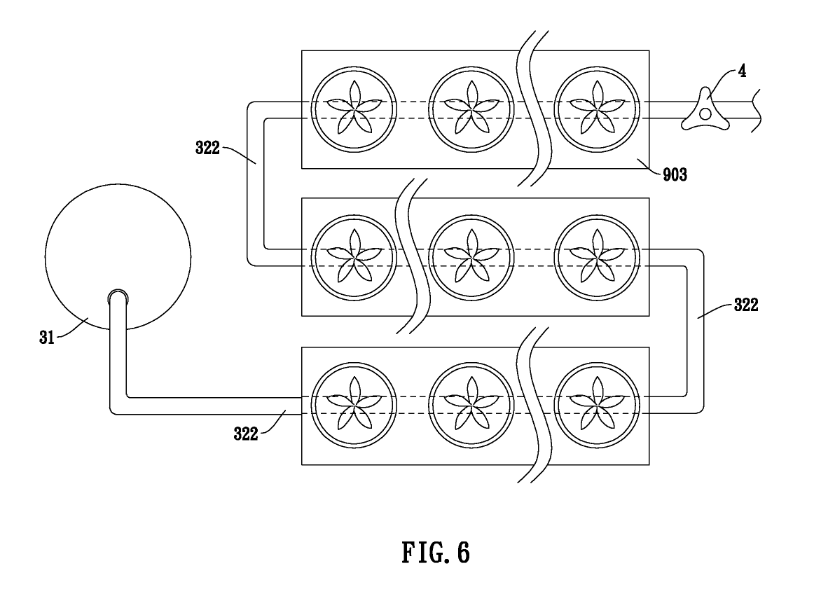

Referring to FIG. 5, a closed capillary water distribution system for planters in accordance with a third preferred embodiment of the invention is characterized below. The water container 905 is eliminated. Instead, a ball shaped float having an arm 907 is mounted on a wall of the water reservoir 31. Further, water can be supplied to the water reservoir 31 from, for example, a tap water system. This is similar to the typical toilet tank in a bathroom.

Referring to FIG. 6, a closed capillary water distribution system for planters in accordance with a fourth preferred embodiment of the invention is characterized below. The fourth preferred embodiment of the invention is similar to the second preferred embodiment of the invention. But the peripheral frames 903 are connected with a S shaped conduit 322 which has one end connect to a faucet 4 and the other end disposed in the water reservoir 31. Therefore, a service personnel can let water flow into the conduit 322 from water source by controlling the faucet 4 and fill up the water reservoir 31. This step can make sure that the conduit 322 will be filled with full of water, and that will ensure the smoothly absorbency of absorbent elements 332. An extension and continuum of capillary rise is generated through out the capillary tubes and the conduit 322, and water could be taken up from a position much lower than the capillary tubes.

While the invention has been described in terms of preferred embodiments, those skilled in the art will recognize that the invention can be practiced with modifications within the spirit and scope of the appended claims.

What is claimed is:

1. A system for transporting water from a water reservoir to planters for watering plants therein, comprising:
a conduit having one end immersed in the water reservoir and the other end closed, the conduit running through undersides of the planters; and
a plurality of capillary tubes each having one end in communication with water flowing in the conduit, and the other end in communication with medium within each planter.

2. The system of claim 1, wherein the capillary tubes are releasable.

3. A system for transporting water from a water reservoir to planters for watering plants therein, comprising:
a conduit having one end immersed in the water reservoir and the other end connected to a pressured water source, the conduit running through undersides of the planters; and
a plurality of capillary tubes each having one end in communication with water flowing in the conduit, and the other end in communication with medium within each planter.

4. The system of claim 3, wherein the capillary tubes are releasable.
